(19) United States
(12) Patent Application Publication
(10) Pub. No.: US 2009/0254412 A1
(43) Pub. Date: Oct. 8, 2009

(54) Methods and systems using targeted advertising

(76) Inventors: Edward Braswell, Nashville, TN (US); Gordon Caldwell, Old Hickory, TN (US); John Hunnicut, Nashville, TN (US); Stephen Prince, Brentwood, TN (US); Jonathan Dyke, Washington, DC (US)

Correspondence Address: PATTON BOGGS LLP, 8484 WESTPARK DRIVE, SUITE 900, MCLEAN, VA, 22102, US

(21) Appl. No.: 12/078,812

(22) Filed: Apr. 7, 2008

(51) Int. Cl. G06Q 30/00; G06Q 10/00

(52) U.S. Cl. 705/10; 705/14

(57) ABSTRACT

Users may provide profile data for determining selected users receiving an offer for a promotion. The selected users may accept or decline the offer. If accepted, value for the offer may be stored on a financial platform for redemption with a party desiring to develop the promotional campaign. Results of the targeted advertising may be monitored, return on investment may be tracked and statistical, predictive and behavioral feedback may be provided to the party desiring to develop the promotional campaign. Future promotions may be adapted based upon the analysis and feedback of users. Promotions may be directly associated with a financial platform, instrument, service or network so that the offer may be automatically redeemed. Profile data may be updated based upon account activity. Promotions may be redeemed via a financial network through point of sale purchases, online purchases, and/or purchases transactions or confirmations utilizing telecommunications platforms.

### FIELD OF THE INVENTION

The invention relates generally to methods and systems for marketing, and, more particularly, to methods and systems for utilizing targeted advertising to distribute promotions via financial products and networks.

### BACKGROUND OF THE INVENTION

Targeted advertising has been used to deliver promotions. Targeted advertising may give a party desiring to develop a promotional campaign an increased ability to reach specific audiences.

In the past, the most efficient way to deliver a message was to blanket the largest mass market audience possible. Early targeted marketing involved directing promotions to individuals within a predetermined zip code, individuals on previous customer lists, and other similar methods. With the advent of usage tracking, customer profiling, and other data mining techniques, it is possible to create more specific targeted marketing campaigns. In particular, the Internet, with content from blogs to social networking sites, may provide a party desiring to develop a promotional campaign with audience information that is well-defined. This may allow for advertisements that are more relevant to viewers and more effective for a party desiring to develop a promotional campaign's marketing efforts. Existing marketing methods based upon targeted advertising, however, have significant drawbacks. It is not always possible to adequately define a targeted audience from publicly available information. Furthermore, there may be significant wastage of advertising revenue during ineffective targeted advertising, resulting in a return on investment that is not easily defined or tracked.

Generally, needs exist for improved methods and systems for marketing using demographic and behavioral data to effectively distribute promotions to specific demographic segments via financial products and networks.

### SUMMARY OF THE INVENTION

Embodiments of the present invention solve many of the problems and/or overcome many of the drawbacks and disadvantages of the prior art by providing methods and systems for marketing based on targeted advertising.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is flow diagram of relationships between members of the methods and systems of the present invention.

FIG. 2 is a schematic diagram of a fund separation system.

FIG. 3 is a flow diagram of the party desiring to develop a promotional campaign side of the methods and systems of the present invention.

FIG. 4 illustrates a load transaction funds flow.

FIG. 5 shows a main account and promotion load transaction fund flow.

FIG. 6 shows a promotion loading flow.

FIG. 7 shows a promotion expiration fund flow.

FIG. 8 shows an alternative purchase funds flow.

FIG. 9 shows a normal purchase funds flow with no promotions.

FIG. 10 shows a normal purchase funds flow with a promotion.

FIG. 11 shows a normal refund funds flow with no promotions.

FIG. 12 shows a normal refund funds flow with a promotion used in an original purchase.

FIGS. 13A and 13B show a retail promotion settlement flow.

FIG. 14 is a schematic diagram of a computer system of the present invention.

FIG. 15 illustrates an embodiment of system architecture.

FIG. 16 illustrates a more detailed interaction of the central organization server with a consumer's web browser and a party desiring to develop a promotional campaign's web browser via the Internet.

FIG. 17 illustrates a server and database configuration.

FIG. 18 illustrates a promotion flow.

FIG. 19 illustrates a distributed agent processing architecture used for real-time or near real-time acquisition of consumer data and behaviors for the purpose of offering purchase incentives.

FIG. 20 illustrates an exemplary domain model.

### DETAILED DESCRIPTION OF THE PREFERRED EMBODIMENTS

Embodiments of the present invention may include methods and systems for marketing based upon targeted advertising within specific demographic groups via financial products or networks. Financial products or networks may include debit services and cards, credit services and cards, payroll services and cards, mobile telephone distribution, radio frequency identification (RFID), or other financial instruments. The term “financial system” as used herein may be understood to mean any applicable financial product or network.

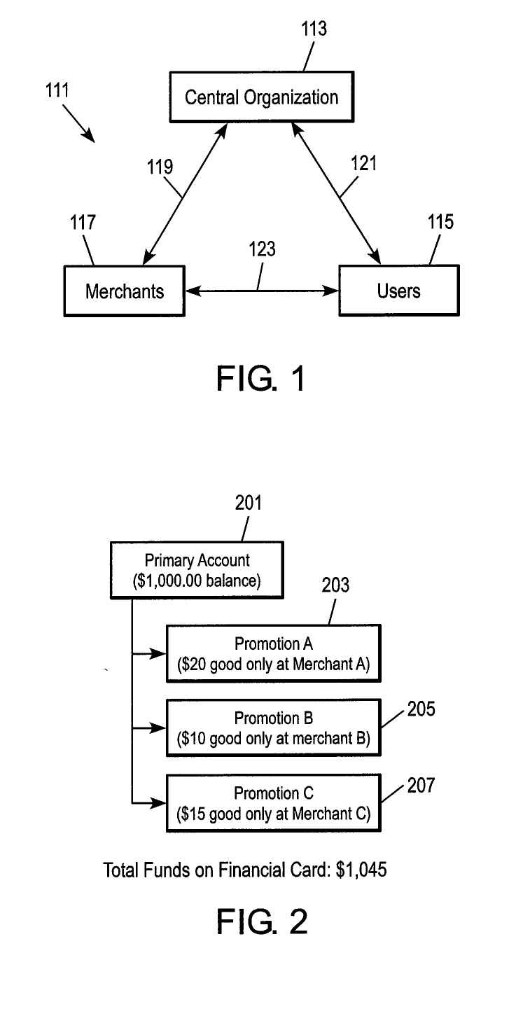

FIG. 1 illustrates an embodiment of a marketing method 111 of the present invention. A central organization 113 may administer the methods and systems of the present invention. The central organization 113 may interact 119 with a party desiring to develop a promotional campaign 117 by providing a marketing platform for promotions. A party desiring to develop a promotional campaign may be any entity desiring to conduct a promotional campaign, such as, but not limited to, retailers, wholesalers, resellers, etc. The party desiring to develop a promotional campaign 117 may interact 119 with the central organization by providing monetary value for promotions. The central organization 113 may also interact 121 with users 115 by providing notification of promotions to users 115. Users 115 may interact 121 with the central organization by accepting promotions. The party desiring to develop a promotional campaign 117 and users 115 may interact 123 through transferring goods and services for monetary value.

Embodiments of the present invention may include a marketing platform for directly targeting select individuals from a pool of users of financial systems. Embodiments of the present invention may be used in combination with existing financial systems or may utilize a procedure for issuing new financial products. A user may open a new account to receive a financial product or choose to link an existing account to the marketing platform of the present invention. Users may register and/or order their financial products with a central organization responsible for administering the methods and systems of the present invention. The registration process may include submitting user profile information and/or demographic information that may be used in targeted advertising. The registration process is described in more detail below. One or more of the registered users of financial products may be included in the pool of users of financial systems for targeted advertising purposes.

A party desiring to develop a promotional campaign cooperating with the central organization may provide funds for a promotion. Promotions are preferably monetary value awards for use at the party desiring to develop a promotional campaign's brick and mortar locations, websites, and/or other retail channels. Alternatively, promotions may be a variety of marketing strategies, such as cash back incentives, for attracting customers. Promotions may be predetermined monetary value discounts, percentage discounts and/or any other types of incentives to attract users to the party desiring to develop a promotional campaign's retail channels. Promotions may preferably have a limited time for acceptance. For example, a possible promotion may be $5.00 provided to a user to be redeemed within 30 days at a party desiring to develop a promotional campaign's location. A monetary incentive may be created by a party desiring to develop a promotional campaign or customized for a particular party desiring to develop a promotional campaign.

Promotions may also be predetermined monetary values issued to financial systems based upon a number of times a particular financial system is used and/or an amount spent with the party desiring to develop a promotional campaign. As with other promotions, the monetary value may preferably only be redeemed with the party desiring to develop a promotional campaign. This may allow the central organization to load promotions based on certain determined by account activity instead of or in addition to demographic type search data.

Embodiments of the methods and systems of the present invention may be integrated with product level promotions. Data may be received from each participating party desiring to develop a promotional campaign regarding product codes, etc. that may allow the central organization to compile a database and/or track product purchases from users. Product purchase data may include, but is not limited to, age, gender, home address, school address, business address, purchase history (both near term and long term historical, all demographic, geographic, psychographic data. Product level information may be captured at the point of sale. Purchase information may be supplied to the party desiring to develop a promotional campaign. Preferably, sharing of purchase information may be confidential and all participating parties may agree to opt in. Shared information may include, for example, purchase information, but preferably does not include specific user profile and/or demographic data. Preferably, only encrypted preferences may be shared, and only as part of a large sample. Information regarding types of purchases and the party desiring to develop a promotional campaign may be shared to more accurately target users for future promotions. Any data shared may only be aggregated according to desired demographic targets. No confidential, individual or proprietary information may be provided through the process of developing or analyzing promotions.

The party desiring to develop a promotional campaign may provide the central organization with criteria for creating a targeted advertising promotion. Criteria may include age, gender, geographic location, school affiliation, purchase history (both near term and long term historical, all demographic, geographic, psychographic data, desired account activity preferences, total financial commitment the party desiring to develop a promotional campaign is willing to invest, the total number of users the party desiring to develop a promotional campaign would like to reach, the total number of users the party desiring to develop a promotional campaign would like to have accept the promotion, the desired promotion run time and amount of each financial commitment per user, and others. The party desiring to develop a promotional campaign may also establish criteria and timeframes for the acceptance phase of the promotion. Users may be required to respond to promotion notification with a day, week month, etc. or the promotion offer may not be valid. Alternatively, as an example, the party desiring to develop a promotional campaign may restrict the promotion to the first five hundred or another predetermined number of users that accept the promotion. Other criteria and timeframes for the acceptance phase of the promotion may be implemented. The central organization may then process the criteria against a database of user profile information. The processing may include operation of a query/algorithm resulting in a non-personal, encrypted listing of the desired target base that the party desiring to develop a promotional campaign can review. The party desiring to develop a promotional campaign may confirm the listing of the desired target base meets the party desiring to develop a promotional campaign's needs for reach, size and potential effectiveness of the program. If the listing of the target base does not meet the party desiring to develop a promotional campaign's needs, the party desiring to develop a promotional campaign may request additional criteria or remove certain criteria based on their specific campaign and promotional needs. The system may suggest behavioral matching based on the algorithm defined by the search criteria.

The system may provide the party desiring to develop a promotional campaign with user profile information, but preferably not personal user information, for users on the listing of the desired target base. The party desiring to develop a promotional campaign may then use the supplied user profile information to determine which users receive an offer for a promotion. A party desiring to develop a promotional campaign may access an online wizard or similar system that may allow the party desiring to develop a promotional campaign to build each promotional program The central organization may work with the party desiring to develop a promotional campaign to create custom promotional campaigns. Retail support technicians at a central organization may walk the party desiring to develop a promotional campaign through the process and help the party desiring to develop a promotional campaign define the promotional campaign in a more consultative manner.

Once the listing of users receiving promotional offer is completed, the party desiring to develop a promotional campaign may be required to remit funds to the central organization sufficient to cover the funds for the entire promotion.

A central organization may then notify the selected users that they have been offered one or more promotions for the selected party desiring to develop a promotional campaign. The notification may be via email, text, RSS, Internet, mail, RFID, phone and/or other means. The users may then choose to accept or decline the offer for a promotion. A user may accept or decline an offer through the same means as the notification or through a different means. For example, a user may receive a text message notification and accept by logging into a website. If a user declines an offer for a promotion, the user's decision may be recorded with the central organization. The party desiring to develop a promotional campaign and/or the central organization may send a feedback survey through the system to users that declined the offer so that the party desiring to develop a promotional campaign and/or central organization may gather data to better address the user's needs or preferences for future offers. If a user accepts an offer for a promotion, the central organization deposits funds to cover the promotion directly onto the financial system of the selected user. The user's acceptance may be recorded with the central organization. The party desiring to develop a promotional campaign and/or the central organization can send a feedback survey through the system to users that accepted the offer so that the party desiring to develop a promotional campaign and/or the central organization may gather data to better address the user's needs or preferences for future offers. The user may select which one or more of the offered promotions they would like to accept.

A user may receive one or more promotions based on user selected preferences. Preferences may include, but are not limited to, a particular party desiring to develop a promotional campaign, types of parties desiring to develop a promotional campaign, dates of availability, etc. Preferences may be set up and changed by logging into a website, contacting the central organization, or through other related methods. Alternatively, a user may browse through available promotions and select any promotions that appeal to the user. To provide maximum exposure for each party desiring to develop a promotional campaign's program, the promotion may be made available to all users at the party desiring to develop a promotional campaign's request. The promotion may then be listed with all other promotions on the website that contain a general availability status. All visitors to the site may be able to view these promotions. Enrolled users may be able to select the available promotions and, like all other offers, the promotions may be added to the user's account balance upon acceptance of the promotion offer. As another alternative, the user may allow the central organization to choose which promotions are offered to the user without indicated any preferences. This may limit the required input from the user, but may result in users receiving promotions that are less relevant to their usage as compared with those users that indicate personal preferences. Users may change preferences at any time from initial registration through account termination.

After accepting one or more promotions, funds specific to the party desiring to develop a promotional campaign for the specific promotion may be loaded onto the user's account through the central organization by debiting funds supplied by the party desiring to develop a promotional campaign at the beginning of the promotion and crediting them to the financial instrument issuing institution. A primary balance on a user's financial system may be used anywhere the financial system is accepted as a form of payment.

As seen in FIG. 2, the funds specific to a party desiring to develop a promotional campaign may be identified on the system as only usable at locations of the party desiring to develop a promotional campaign. The systems and methods of the present invention may use an account/sub-account system to keep funds set aside for specific promotional campaigns for a party desiring to develop a promotional campaign separate from funds set aside for other parties desiring to develop promotional campaigns. A primary account 201 may contain funds deposited by a user. There may be one or more sub-accounts for each promotion accepted by the user. In FIG. 2, a first sub-account 203 holds funds ($20) deposited by the central organization for Promotion A valid only at Merchant A, a second sub-account 205 holds funds ($10) deposited by the central organization for Promotion B valid only at Merchant B, and a third sub-account 207 holds funds ($15) deposited by the central organization for Promotion C valid only at Merchant C. In FIG. 2, the total balance on the account may be $1,045 when the primary account and sub-accounts are combined.

Funds in a primary account and sub-accounts may be separated in a fund tracking system from other funds previously held by the user in the primary balance. The user may then visit the party desiring to develop a promotional campaign's brick and mortar locations, website or other channels of trade to redeem the promotion. The promotion value may only be redeemable at locations specified by the party desiring to develop a promotional campaign and not at other locations. A main account in the financial system, in contrast, may be used to redeem value anywhere the financial system is accepted as payment. The promotion may be automatically redeemed during the transaction at the party desiring to develop a promotional campaign's store, website or retail channel without any further action by the user or employees at the party desiring to develop a promotional campaign's store, website or retail channel. Authorization of the total transaction costs on the user's account may be interrupted at the point of sale to verify the relevant promotion and whether promotional funds exist on the financial system for at the relevant promotion. For example, to process a $100.00 transaction at a party desiring to develop a promotional campaign where a user has a $5.00 promotion, $5.00 are withdrawn from funds in a sub-account allocated for the promotion by the party desiring to develop a promotional campaign and $95.00 are withdrawn from the primary account of the user's account. Only the user and the party desiring to develop a promotional campaign's marketing department may be aware of the application of the promotion to the checkout. Detailed promotion information may be available at the point of sale for those locations with sufficient systems to accommodate and display the data.

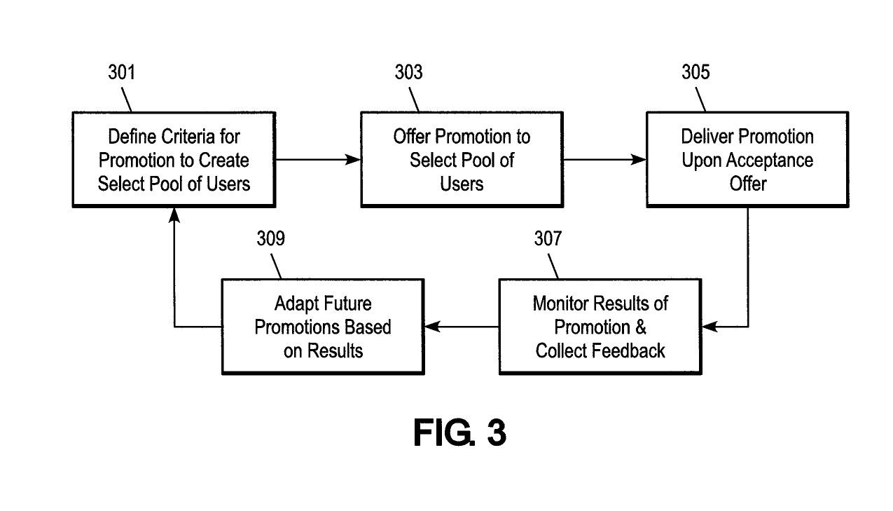

The methods and systems of the present invention may provide immediate feedback to the party desiring to develop a promotional campaign regarding the effectiveness of the promotion. The feedback can be selected for real-time or batched availability and submitted to the party desiring to develop a promotional campaign at intervals determined by the party desiring to develop a promotional campaign. FIG. 3 illustrates methods and systems for interactions between the central organization and the party desiring to develop a promotional campaign. Initially, a party desiring to develop a promotional campaign may define criteria for a promotion such that the criteria create a pool of selected users 301. Promotions may then be offered to the pool of selected users 303. Promotions may be delivered to users that accept the promotion 305. The central organization may monitor the results of the promotion and collect feedback from users 307. Future promotions may be adapted based upon the results and collected feedback 309.

A party desiring to develop a promotional campaign may be notified when promotions are offered, accepted and/or redeemed. The methods and systems of the present invention further provide information on which users do not accept or redeem promotions before the end of the promotional period. This information may also be useful in designing future promotions. During the promotion period and after the promotional period ends, the central organization may provide the party desiring to develop a promotional campaign with data regarding the acceptance of promotional offers, the redemption of promotions, the effectiveness of the targeted marketing and other information. The central organization may process the data before sending the data to the party desiring to develop a promotional campaign or the data may be sent to the party desiring to develop a promotional campaign without further processing. The following represents an example of data captured and analyzed for the party desiring to develop a promotional campaign: gender, age, home zip code, school zip code, home city, home state, school city, school state, communication method preference (text, email, etc.), interested in product reviews and surveys, retail type preferred, food, hospitality, entertainment, miscellaneous services, financial instrument usage, places, frequency, standard industrial classification (SIC) code, party desiring to develop a promotional campaign identification number (MID), response time, by designed program filters, by duration of acceptance, average acceptance timeframe, by filter response rate, by filter grouped rate, ability to group filters in any number of scenarios, total purchase amount, transaction timestamp, acceptance to redemption duration, promotion amount used, general purpose balance used with promotion, and/or promotions remaining/unused.

Any unused funds supplied by the party desiring to develop a promotional campaign for the promotion may be returned to the party desiring to develop a promotional campaign minus any administration fees charged by the central organization. The settlement process with the party desiring to develop a promotional campaign may vary depending on various factors. The return of any used funds held in escrow by the central organization may depend on how quickly the party desiring to develop a promotional campaign requires a refund, chargeback relationships, how many current promotions are running, and how current promotions are all tied to the escrow, etc. This may vary widely between parties desiring to develop a promotional campaign depending on a number of variables such as size, clout, position, etc.

Based upon the tracked data, future offerings may be adapted to improve performance for the party desiring to develop a promotional campaign. Tracked data may be based on behavioral feedback and may establish a set of decision rules based on the data collected. For example, users age 13-16 may typically take over seven days to redeem a promotion because they may not have ready access to adequate transportation to allow quicker redemption. By default, specific program data and results may not be shared with other parties desiring to develop a promotional campaign.

The following is an exemplary use of the methods and systems of the present invention. The following is merely a simplified example, and other variations are possible.

A restaurant may operate within a given community. A restaurant owner may want to introduce the restaurant to new residents of the community and/or remind existing residents about the restaurant. The restaurant may contact the central organization and request a promotional campaign. A promotional campaign may be $5.00 to spend at the restaurant within the next 30 days. The promotion may or may not be tied to a specific product. Other examples are possible including different monetary values, different restrictions, different expiration periods and other limitations. The restaurant owner may identify targeted types of users of the financial systems via one or more parameters such as zip code, age, gender, account activity preferences indicated in the user profile, actual account activity history of the user, etc. The central organization may analyze the user profiles of all registered users and determine that 1,200 users meet the restaurant owner's parameters. The restaurant owner may then supply funds to cover the promotion to the central organization. In this example, the restaurant owner may supply the central organization with $5.00×1200 users=$6,000.00. The central organization may then notify the selected 1,200 users that they have been offered a promotion at the restaurant. Users may then decline or accept the offer for a promotion as long as the users have accepted within the defined acceptance timeframe. It may be assumed for this example that 50% (600 users) may accept. If the user declines the promotion, the central organization stores this information. If the user accepts the promotion, the central organization may deposit $5.00 in value onto the user's financial system. The $5.00 in value may be used only at the restaurant. At the time of purchase at the participating party desiring to develop a promotional campaign (restaurant in this example), the transaction may be authorized at the point of sale similarly to other normal purchase transactions. When the authorization is being obtained, however, the system may verify promotional funds on the financial instrument for that party desiring to develop a promotional campaign. If funds exist and are usable, those funds may be used before the balance of the transaction is authorized through funds in the financial instrument's general balance fund or account. In fact, the party desiring to develop a promotional campaign may not even be notified through existing point of sale devices and may see an authorization or decline for the entire transaction similarly to existing processes. The redemption of the promotion may be recorded by the central organization. Data regarding acceptance and redemption of promotions may be recorded and processed.

The methods and systems of the present invention may be administered over the Internet, telecommunications networks and/or payment networks. For example, financial systems may be activated and managed through an interactive website, telephone based customer support, interactive voice recognition (“IVR”) system, email, etc. Financial systems may be activated by accessing an activation website or activation IVR. For new users of a financial system, a user may enter an account number and initial password into the website to activate a financial instrument. A financial instrument number and initial password may be entered into a command prompt. Financial instrument numbers and initial passwords may preferably be found on the financial system or with packaging associated with the financial system. The initial password may be changed after activation to a password selected by the user. For existing users of financial systems of the present invention, a user may enter a new financial system number and an email address or other form of identification.

New users may be prompted to enter user profile information. Existing users may confirm user profile information and/or make changes to an existing profile. The methods and systems of the present invention may leverage existing social networks for financial system distribution and product feedback.

User profile information may include, but is not limited to, name, address, age, email address, phone numbers, social security numbers, birthdates, personal preferences, etc. A user profile may further include purchase data and/or other purchase information. A user profile may be updated whenever the financial system is used to make purchases. The user profile may also be updated anytime by the user. The purchase data may be integrated with the user supplied profile information to create more accurate targeted promotions. For example, a user may create a profile indicating that preferred stores include auto parts, sporting goods and electronics. Purchase data, however, may indicate that a majority of purchases and value of the financial instrument is spent on groceries and children's toys. Therefore, the purchase data may be incorporated into the user profile information such that the user receives promotions for groceries and children's toys as well as the user identified categories. The integration of more data may allow for more successful and effective behavioral advertising.

A user may submit user profile information at anytime, but a user cannot, edit, remove or otherwise delete their account activity data and history. A financial system may be activated immediately upon submission of initial user profile information or at a predetermined time after submission of the user profile information. A user may further create a personal identification number (PIN to use the financial system at automated teller machines (ATM) worldwide.

As part of the user profile information, a user may enter preferences for types of promotions and delivery options that may be available to the user. A user may select the types of offers, categories of parties desiring to develop a promotional campaign, frequency of offers, etc. A user may select to be notified when value is added to the financial system, when value is added to the financial system by others, when promotions are received, when account balances fall below a predetermined level, rise above a predetermined level, all of the foregoing, various combinations of the foregoing, or no notifications. Notifications may be delivered by email, text, RSS, mail, phone and/or any other suitable delivery methods as selected by the user.

A user may determine what promotions are currently loaded onto a financial system by logging in to a central website. A login may include name, birthday, social security number, email address, and/or other personal information. Once logged in, the user may see listings and descriptions of current promotions on the financial system.

New financial systems may be requested by a user for personal use or by a user for another user. Alternatively, value may be added to existing financial systems by the user or by others for the benefit of the user. Parental controls may be available for users. Value may be added to a financial system in a lump sum, or as a recurring deposit for a predetermine value, a predetermined interval and/or a predetermined duration. Value may be added through a central website. Value may be added by transferring money from other bank accounts, payroll direct deposit or with debit/credit financial instruments. Additionally, funds may be added to the financial instrument via an Automated Clearing House (“ACH”).

After activating a financial system, the financial system may be used as a standard financial system. Non-promotional funds may be general purpose and may be used anywhere the financial instrument brand is accepted. A user may login to a central website to access current financial system status. Each user may have that user's personal profile information displayed on a personalized website. The personalized website may display current balance on the financial system, account activity such as purchases, deposits and gifts, received promotions, accepted promotions, used promotions, and other relevant information. The personalized website may also have options for adding value to a financial system, viewing available promotions, and viewing current promotions. The personalized website may also allow for updating the user's personal profile.

A central website may solicit comments and other input from users regarding experiences with the methods and systems of the present invention. Prizes, promotions and other offers may be provided as incentives for completing surveys or offering comments or other input from users. Additionally, party desiring to develop a promotional campaign may directly solicit input regarding promotions from targeted users.

A party desiring to develop a promotional campaign may have access to a separate and/or distinct website. A party desiring to develop a promotional campaign may access the website to submit proposals for promotion campaigns, track existing campaigns and/or review past campaigns.

Fund transfer mechanisms may be included in the methods and systems of the present invention.

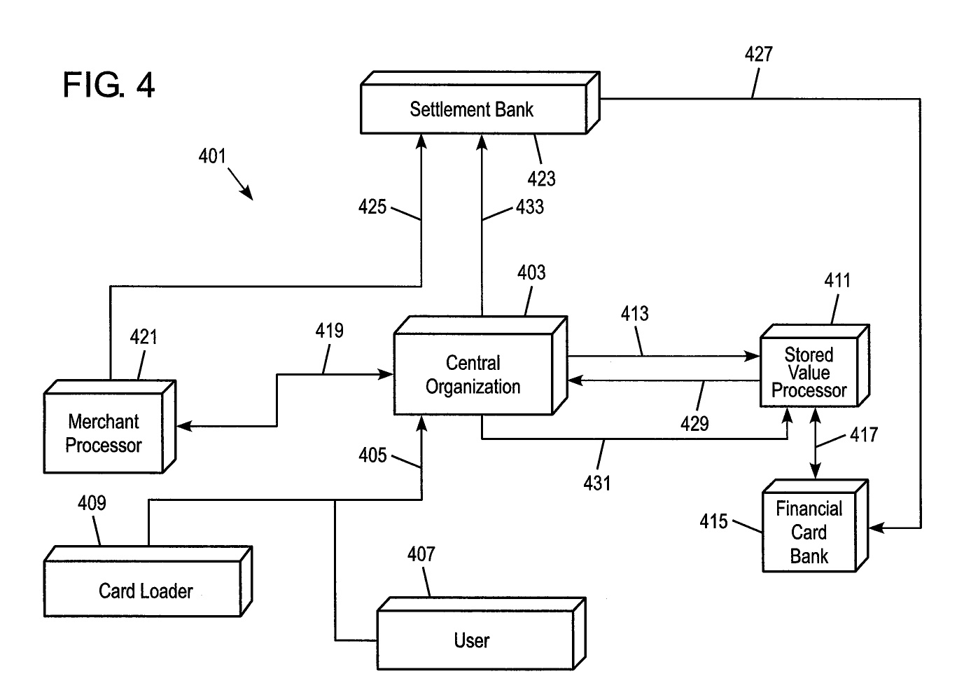

FIG. 4 illustrates an exemplary load transaction funds flow 401. Funds 405 may be submitted to a central organization 403 for storing on a financial system. Funds 405 may be added by a user 407 or a financial instrument loader 409 adding value for to the user's financial system. The user 407 and the financial instrument loader 409 may be the same. The transaction 405 may be a credit, debit or check transaction for loading value onto a financial system. The transaction 405 may be processed through the central organization's website, telephone system or other suitable methods.

The central organization 403 may request and/or receive authorization 419 for the load transaction 405 from a party desiring to develop a promotional campaign processor 421.

The central organization 403 may then send 413, via an application program interface (API), information to a stored value processor 411 regarding the requested load transaction. Detailed financial instrument load information 413 may be sent to the stored value processor 411. The financial instrument load information may have a batch identification, total transaction amount, total amount submitted, etc. The detailed financial instrument load information 413 may also include detailed financial instrument level load instructions. The detailed financial instrument level load instructions may allow, at a predetermined time or based upon a predetermined frequency, approved funds to be transferred 427 from a settlement bank 423 to a financial system bank 415. When funds are deposited to the financial system, then date, time, and other relevant information may be captured.

The stored value processor 411 may post load information to individual financial instruments. This may move balances from a main funding demand deposit account to a main funding virtual financial instrument. Any balances or amounts not posted or balances or amounts rejected for whatever reason may be communicated 429 back to the central organization 403. Alternatively, the stored value processor 411 may then send a confirmation report 429 back of all balances updated. The stored value processor 411 may confirm 417 with the financial system bank 415 that funds are available.

The central organization 403 may initiate an automated clearing house (“ACH”) 433 to move load funds 427 directly to the financial system bank 415. The central organization 403 may also send a notification 431 to the stored value processor 411 to alert the stored value processor 411 that a batch transaction has been initiated. The notification 431 may contain total transaction amount, batch identification date, etc.

A settlement 425 from the party desiring to develop a promotional campaign processor 421 may be received into a settlement account at the settlement bank 423. An acknowledgement may or may not be sent for successful transactions.

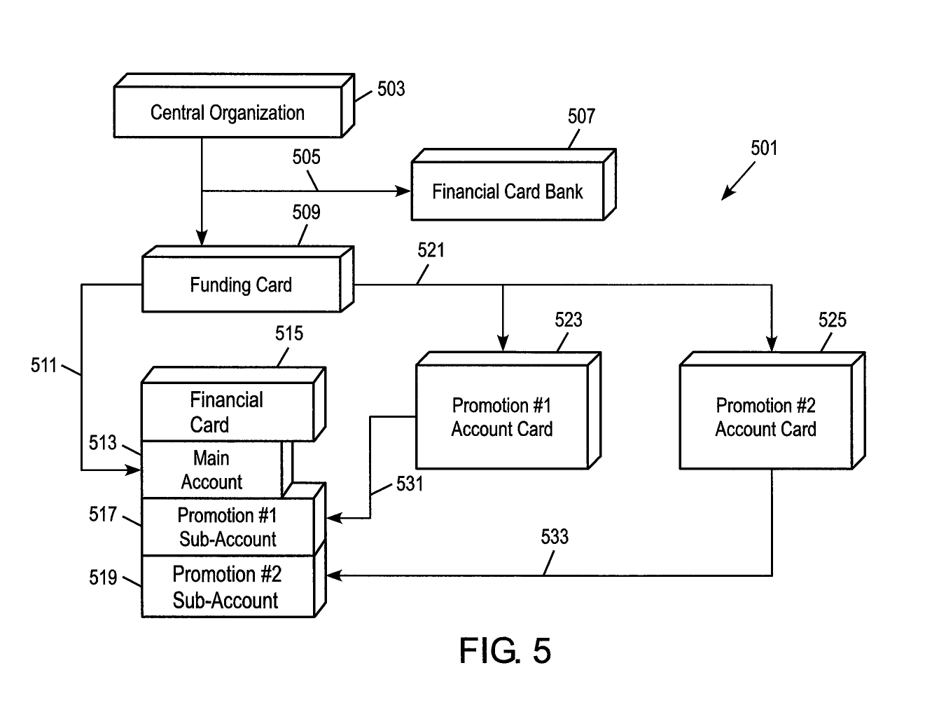

FIG. 5 shows a main account and promotion load transaction fund flow 501. A central organization 503 may send an ACH 505 to a financial system bank 907. The ACH 505 may be for the amount of the fund loading. The central organization 503 may also send a notification to a stored value processor (not shown) alerting the stored value processor to the incoming ACH 505. Funds may be deposited at the financial system bank 507 and credited to a funding financial instrument 509.

Any loads 511 intended for a main cash account 513 on a financial system 515 may have this information, such as financial instrument number, amount, etc., via an API for the stored value processor. These transactions may occur throughout a day.

Loading promotions to the financial system 515 may occur in a two-step process. The funds may have already been remitted to the funding financial instrument 509, but need to be posted to specific accounts 517, 519 on individual financial systems 515. A financial instrument to financial instrument transfer 521 may be completed by the stored value processor. Promotions may be for more than one party desiring to develop a promotional campaign. For example, a first promotion may be for a first party desiring to develop a promotional campaign and a second promotion may be for a second party desiring to develop a promotional campaign. The parties desiring to develop promotional campaigns are separate entities and the first promotion may not be valid with a second party desiring to develop a promotional campaign and the second promotion may not be valid with the first party desiring to develop a promotional campaign. Funds for the first promotion may be transferred to the promotion #1 account financial instrument 523 and funds for the second promotion may be transferred to the promotion #2 account financial instrument 525.

Once funds are on the promotion account financial instruments 523, 525, the funds may be moved to individual financial systems 515 according to the users that have accepted the promotions. An API may transfer 531 funds for the first promotion from the promotion #1 account financial instrument 523 to a promotion #1 account 517 on the individual financial instrument 515. Furthermore, the API may transfer 533 funds for the second promotion from the promotion #2 account financial instrument 525 to a promotion #2 account 519 on the individual financial instrument 515. This funds transfer may be communicated to the stored value processor via the API. Similar systems may be applied when funds are loaded to individual financial instruments by financial instrument loaders other than the user.

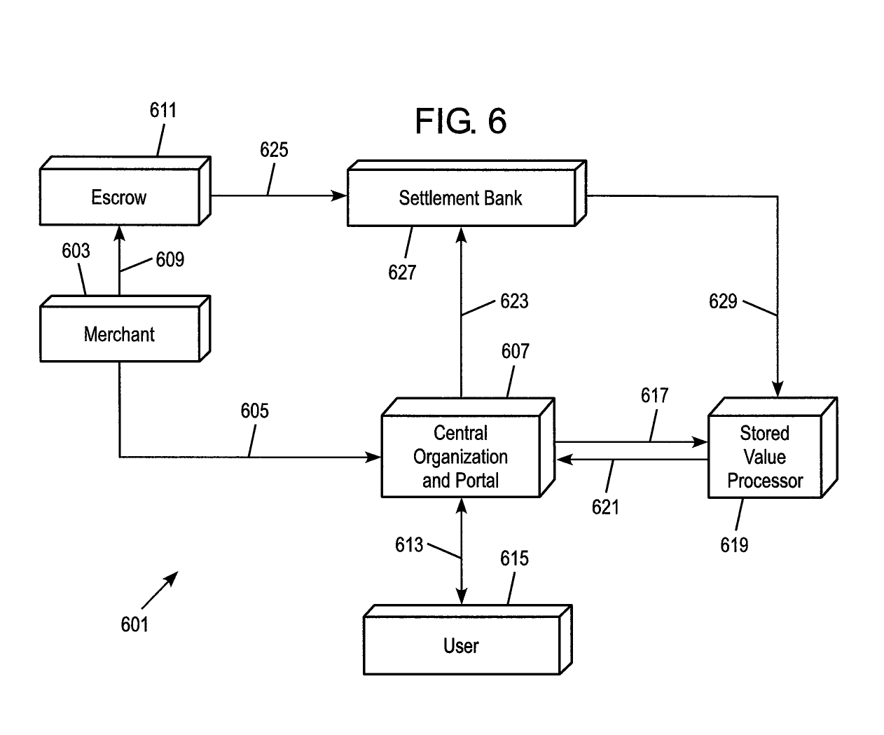

FIG. 6 shows a promotion loading flow 601. A party desiring to develop a promotional campaign 603 may initiate 605 a promotional program via a portal operated by a central organization 607. The party desiring to develop a promotional campaign 603 may then deposit 609 required funds into an escrow 611 via AC wire or other transfer mechanism.

The central organization 607 may communicate 613 the promotion to a user 615 and may receive an acceptance from the user 615. Upon receipt of an acceptance, the central organization 607 may send information 617 to load a financial system to a stored value processor 619. The stored value processor 619 may send 621 an approval code or a decline code to the central organization 607 to make funds available.

The central organization may initiate 623 a transfer 625 of funds from the escrow 611 to a settlement bank 627 and transfer 629 the funds to the stored value processor 619 for the promotional load amount.

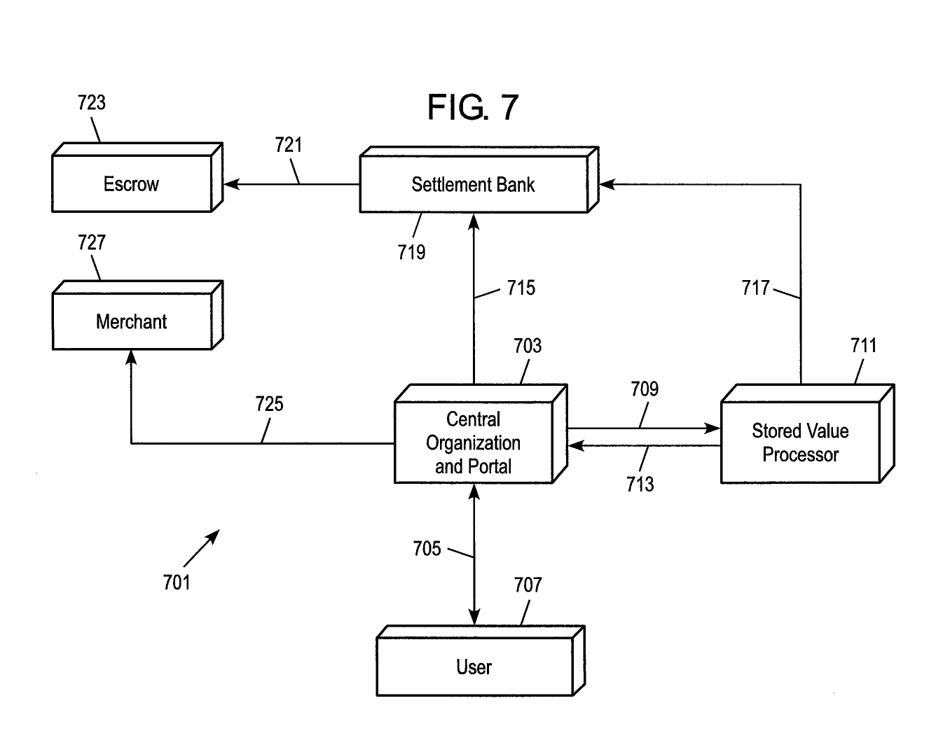

FIG. 7 shows a promotion expiration fund flow 701. A promotion may expire per the parameters set in the original description and agreement regarding the form and duration of the promotion. A portal for a central organization 703 may reflect 705 the expiration of the promotion to a user 707. The central organization 703 may send 709 information to a stored value processor 711 to remove balance from an account. The stored value processor 711 may send 713 an acknowledge code to the central organization 703 to remove funds. The central organization 703 may initiate 715 a transfer 717 of funds from the stored value processor 711 to a settlement bank 719 and then transfer 721 the funds to an escrow 723. The central organization 703 may then confirm 725 with a party desiring to develop a promotional campaign 727 the results of the promotion and residual funding.

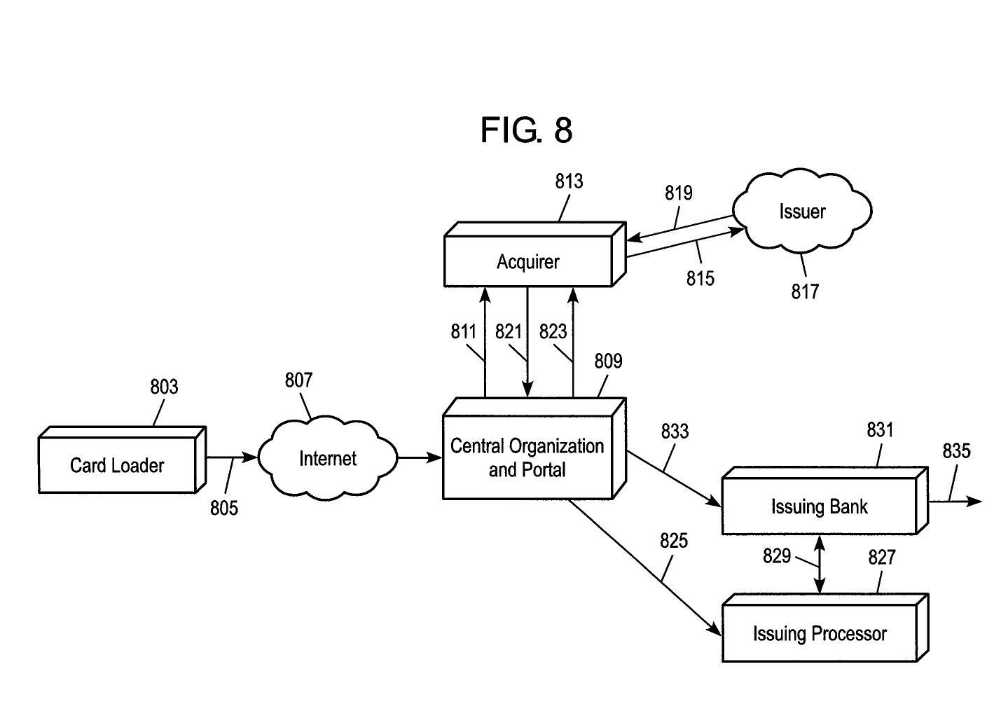

FIG. 8 shows an alternative purchase funds flow diagram 801. A financial instrument loader 803 may complete payment 805 via a secure online portal over the Internet 807 or via another payment method to load a financial system. The payment 805 may be authorized and approved by a central organization 809 in a communication 811 with an acquirer 813, which may in turn communicate 815 with an issuer 817. Funds may be deposited 819 from the issuer 817 to the acquirer 813 and deposited 821 to the central organization 809. The funds may then be available to the user. Processing fees may be debited 823.

An activity file may be remitted 825 to an issuing processor 827. The issuing processor may communicate 829 with an issuing bank 831 to create and ACH file. Settlement funds for financial instrument loads may be debited 833 from the central organization at a predetermined time after authorization. The issuing 831 bank may remit 835 funds for subsequent user purchases. The use of this method and system allows no funds to be held at the central organization 809 for financial instrument load transactions.

The method of FIG. 8 describes fees paid by a loader. For example, the user 803 may submit $105 to load $100 on a financial system. Alternatively, the fees may be paid by the loadee. The method is similar to that of FIG. 8, except the user 803 only submits $100 to load $100 on a financial system. The issuer 817 may deposit $105 to the central organization 809 to cover the fees. After the issuing bank 831 remits 835 funds for subsequent user purchases, the central organization 809 may debit the user account for the load fee via the issuer 817.

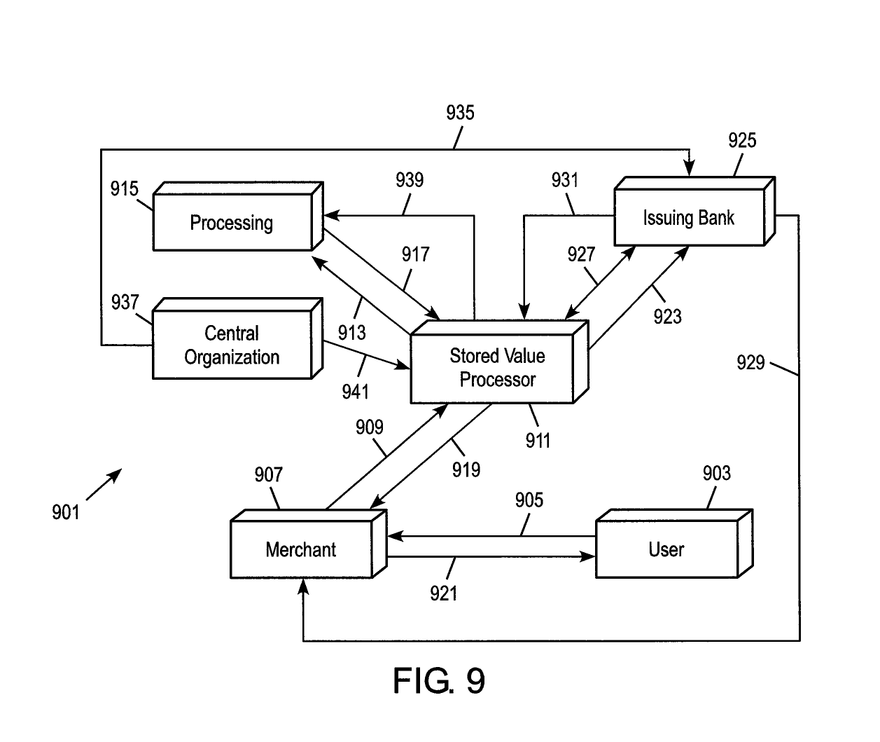

FIG. 9 shows a normal purchase funds flow with no promotions 901. A user 903 may present 905 a financial system for payment to a party desiring to develop a promotional campaign 907. An authorization message 909 may be sent from the party desiring to develop a promotional campaign 907 to a stored value processor 911 and then sent 913 from the stored value processor 911 to processing 915. An authorization returned/approval message may be returned 917 from the processing 915 to the stored value processor 911 and then sent 919 to the party desiring to develop a promotional campaign 907 and then sent 921 to the user 903.

A message 923 regarding the transaction may be sent from the stored value processor 911 to an issuing bank 925. An ACH 927 may be prepared between the issuing bank 925 and the stored value processor 911. An ACH credit 929 to fund the purchase may be sent from the issuing bank 925 to the party desiring to develop a promotional campaign 907. The net of fees 931 may be remitted to the stored value processor 911. An ACH debit to cover funds may be sent 935 from a central organization 937 to the issuing bank 925. Data 939 may be sent, confirmed and/or reconciled between the processing 915 and the stored value processor 911 on a predetermined schedule. Transaction fees 941 may be collected for purchases.

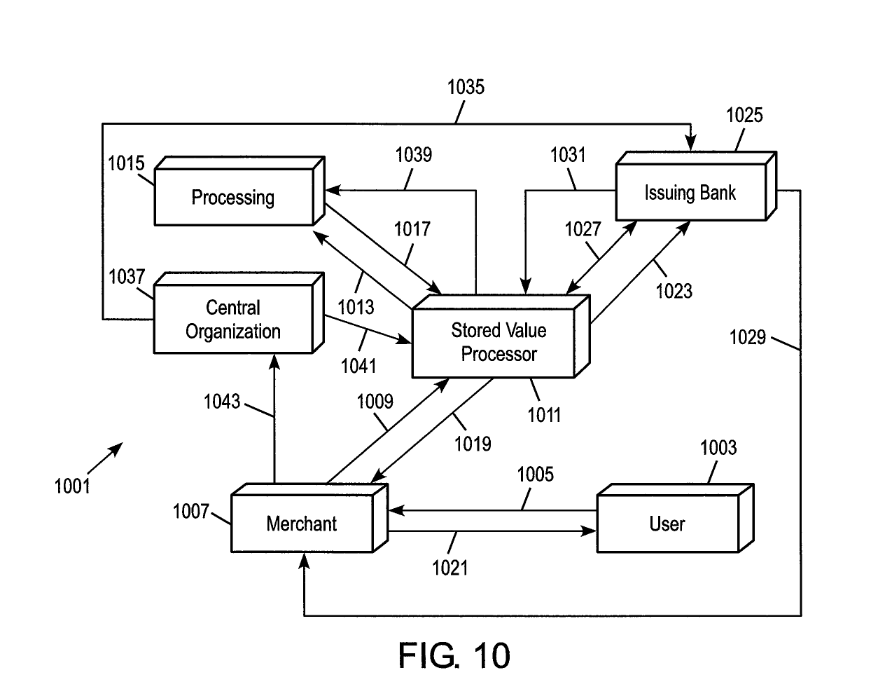

FIG. 10 shows a normal purchase funds flow with a promotions 1001. A user 1003 may present 1005 a financial system for payment to a party desiring to develop a promotional campaign 1007. An authorization message 1009 may be sent from the party desiring to develop a promotional campaign 1007 to a stored value processor 1011 and then sent 1013 from the stored value processor 1011 to processing 1015. An authorization returned/approval message may be returned 1017 from the processing 1015 to the stored value processor 1011 and then sent 1019 to the party desiring to develop a promotional campaign 1007 and then sent 1021 to the user 1003.

A message 1023 regarding the transaction may be sent from the stored value processor 1011 to an issuing bank 1025. An ACH 1027 may be prepared between the issuing bank 1025 and the stored value processor 1011. An ACH credit 1029 to fund the purchase may be sent from the issuing bank 1025 to the party desiring to develop a promotional campaign 1007. The net of fees 1031 may be remitted to the stored value processor 1011. An ACH debit to cover funds may be sent 1035 from a central organization 1037 to the issuing bank 1025. Data 1039 may be sent, confirmed and/or reconciled between the processing 1015 and the stored value processor 1011 on a predetermined schedule. Transaction fees 1041 may be collected for purchases. Promotions may be funded 1043.

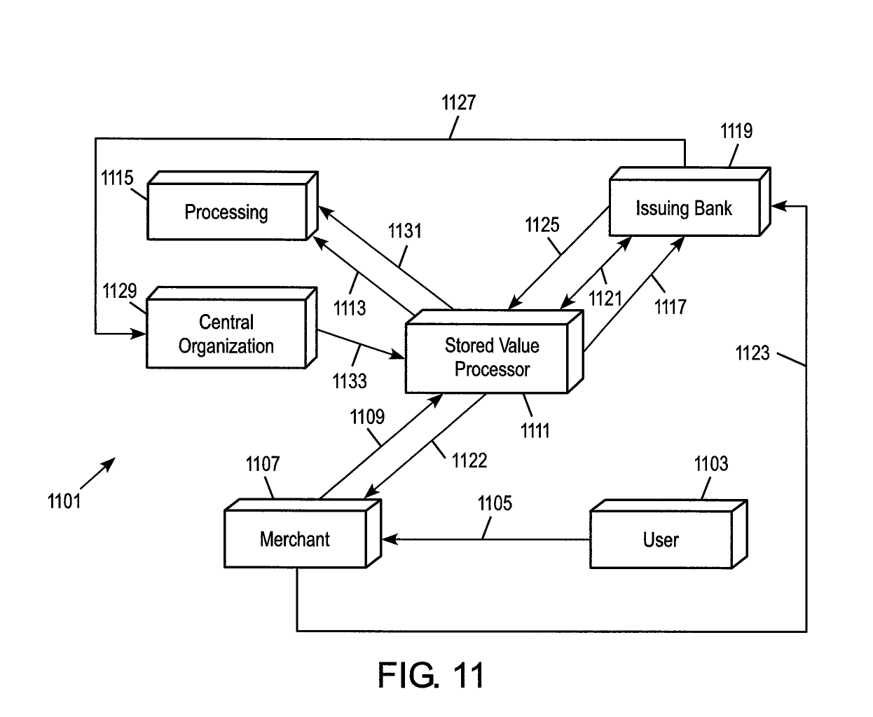

FIG. 11 shows a normal refund funds flow with no promotions 1101. A user 1103 may initiate 1105 a refund with a party desiring to develop a promotional campaign 1107. A forced transaction may be sent 1109 from the party desiring to develop a promotional campaign 1107 to a stored value processor 1111 and then sent 1113 from the stored value processor 1111 to processing 1115. A copy 1117 may be sent to an issuing bank 1119.

An ACH 1121 may be prepared between the issuing bank 1119 and the stored value processor 1111 and then sent 1122 to the party desiring to develop a promotional campaign 1107. An ACH debit to cover funds may be sent 1123 from the party desiring to develop a promotional campaign 1107 to the issuing bank 1119. A net of fees 1125 may be remitted to the stored value processor 1111. An ACH credit to fund the purchase may be sent 1127 from the issuing bank 1119 to a central organization 1129. Data 1131 may be sent, confirmed and/or reconciled between the processing 1115 and the stored value processor 1111 on a predetermined schedule. Transaction fees 1133 may be collected for purchases.

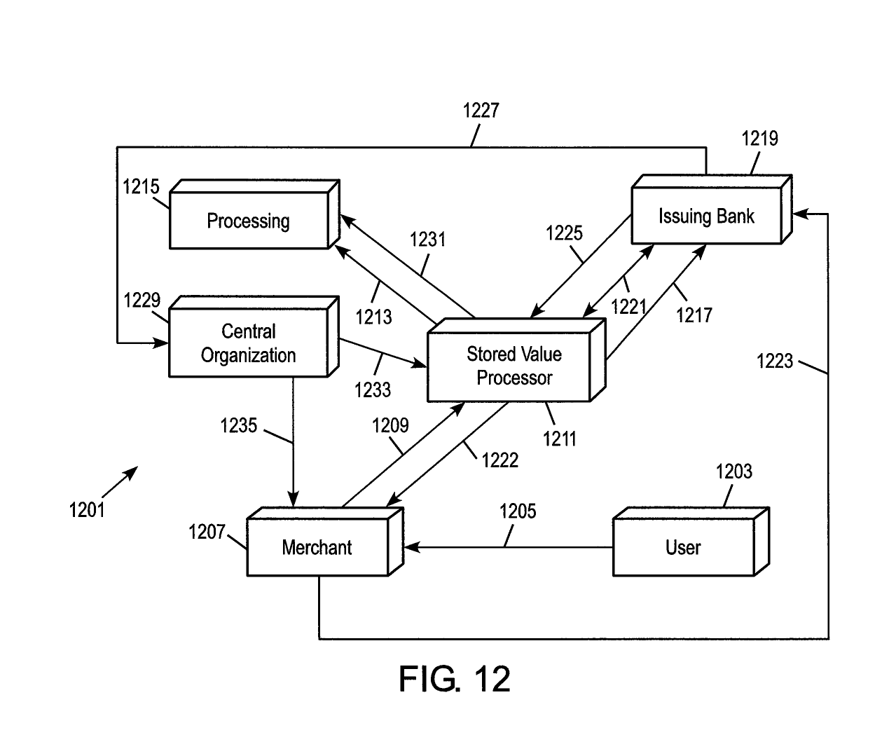

FIG. 12 shows a normal refund funds flow with a promotion used in an original purchase 1201. A user 1203 may initiate 1205 a refund with a party desiring to develop a promotional campaign 1207. A forced transaction may be sent 1209 from the party desiring to develop a promotional campaign 1207 to a stored value processor 1211 and then sent 1213 from the stored value processor 1211 to processing 1215. A copy 1217 may be sent to an issuing bank 1219.

An ACH 1221 may be prepared between the issuing bank 1219 and the stored value processor 1211 and then sent 1222 to the party desiring to develop a promotional campaign 1207. An ACH debit to cover funds may be sent 1223 from the party desiring to develop a promotional campaign 1207 to the issuing bank 1219. A net of fees 1225 may be remitted to the stored value processor 1211. An ACH credit to fund the purchase may be sent 1227 from the issuing bank 1219 to a central organization 1229. Data 1231 may be sent, confirmed and/or reconciled between the processing 1215 and the stored value processor 1211 on a predetermined schedule. Transaction fees 1233 may be collected for purchases. Refunds 1235 of promotions may be made on a predetermined schedule.

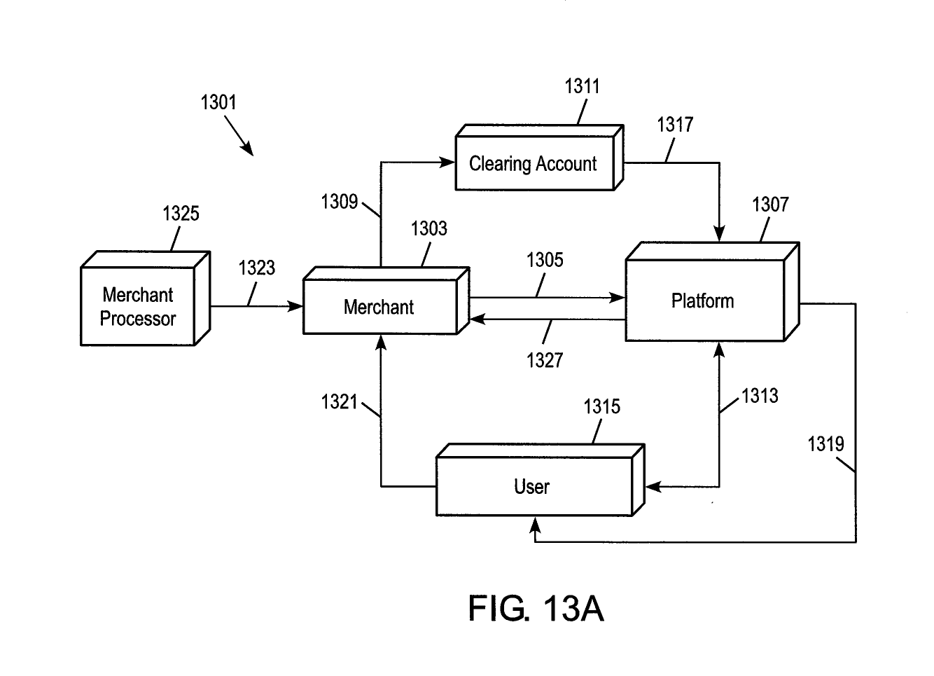

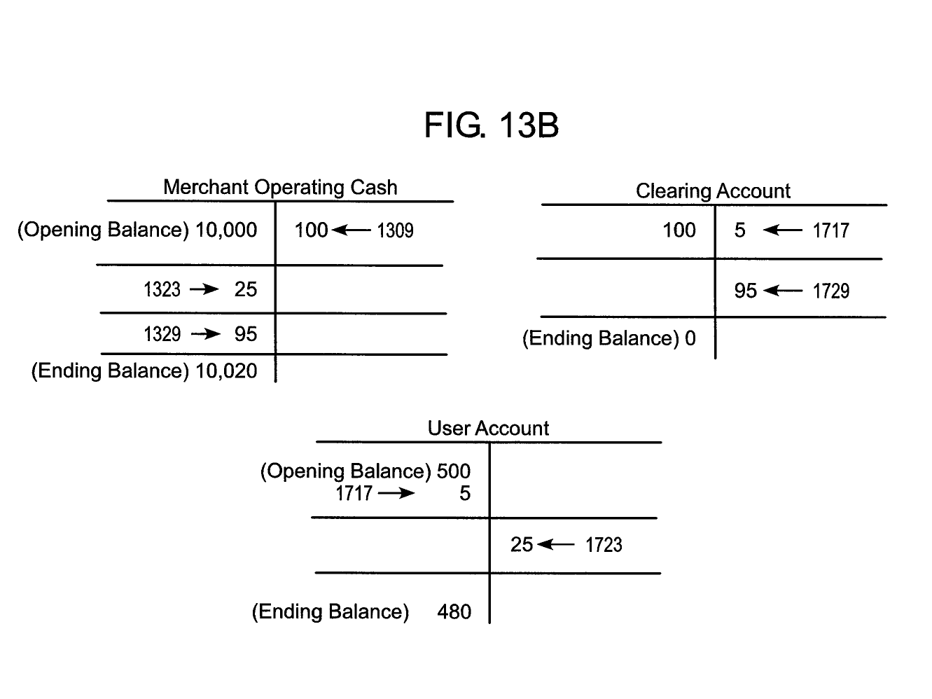

FIGS. 13A and 13B show a party desiring to develop a promotional campaign promotion settlement flow 1301. A party desiring to develop a promotional campaign 1303 may create 1305 a program with promotion creation platform 1307. The party desiring to develop a promotional campaign 1303 may fund 1309 a clearing account 1311 based on promotion parameters.

The platform 1307 may notify 1313 a user 1315 of a promotion and may receive an acceptance of the promotion. The platform 1307 may initiate 1317 an ACH for sufficient funds from the clearing account 1311 based on acceptance levels. A promotion may be loaded 1319 to a financial system of a user 1315. The user 1315 may redeem 1321 the promotion at the party desiring to develop a promotional campaign 1303. The party desiring to develop a promotional campaign 1315 may receive 1323 a settlement for the transaction, including the promotion, from a party desiring to develop a promotional campaign processor 1325. Real-time, post-program and other analytics may be made available 1327 to the party desiring to develop a promotional campaign 1303 by the platform 1307. Remaining funds may be returned 1329 to the party desiring to develop a promotional campaign 1303.

The methods and systems of the present invention may provide many benefits for users over conventional targeted advertising systems. The following are select examples of benefits, but are not intended as a complete listing. Using embodiments of the present invention, a user may benefit from using existing financial systems that are widely accepted around the world. Furthermore, a user may no longer be limited to individual location gift financial instruments. The existing financial systems may be low-fee, pre-paid debit financial instruments that allow a user to put money onto the financial system, have others load money onto the financial instrument online, use the financial instrument at ATMs and with the party desiring to develop a promotional campaign worldwide. Promotions may be placed on the financial systems as incentives for users to visit retail stores or websites. Users may select preferences regarding what promotions are offered. Users may be rewarded with additional bonuses by filling out customer surveys or otherwise submitting information. Users may be able to access their profile from anywhere to see gifts, balances, and pending promotions, load a financial system or share a gift with another user. Users may easily sign up online with little to no time spent trying to figure out complicated fees or balancing checkbooks. Embodiments of the present invention may require no long term commitment. Embodiments of the present invention may provide safe, secure transactions and protection from unauthorized transactions. Users may further benefit from learning healthy account activity habits. Access may be provided to budget templates, latest tips on saving, best student loans, and other savings tools. Furthermore, embodiments may allow young users to start learning financial independence and in addition to taking advantage of promotions.

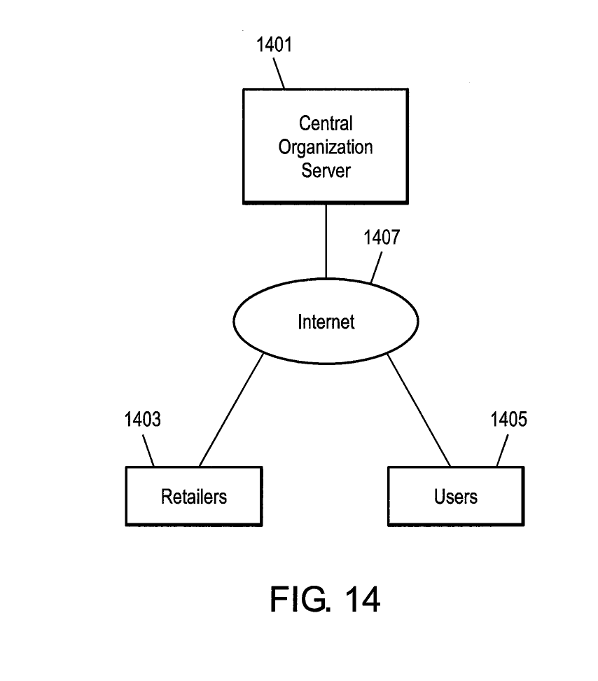

FIG. 14 illustrates a general overview of a system for performing the methods and systems of the present invention. Computerized methods and systems may be used to implement the promotions and financial services of the present invention. Users 1405 and a party desiring to develop a promotional campaign 1403 may connect to a central organization server 1401 through the Internet, WAN, LAN or any other suitable network 1407. The central organization server may process the necessary data to perform the methods and systems of the present invention.

A machine-readable medium may include encoded information, which when read and executed by a machine causes, for example, the methods and systems of the present invention to be executed. The machine-readable medium may store programmable parameters and may also store information including executable instructions, non-programmable parameters, and/or other data. The machine-readable medium may comprise read-only memory (ROM), random-access memory (RAM), nonvolatile memory, an optical disk a magnetic tape, and/or magnetic disk The machine-readable medium may further include, for example, a carrier wave modulated, or otherwise manipulated, to convey instructions that can be read, demodulated/decoded and executed by the machine (e.g., a computer). The machine may comprise one or more microprocessors, microcontrollers, and/or other arrays of logic elements.

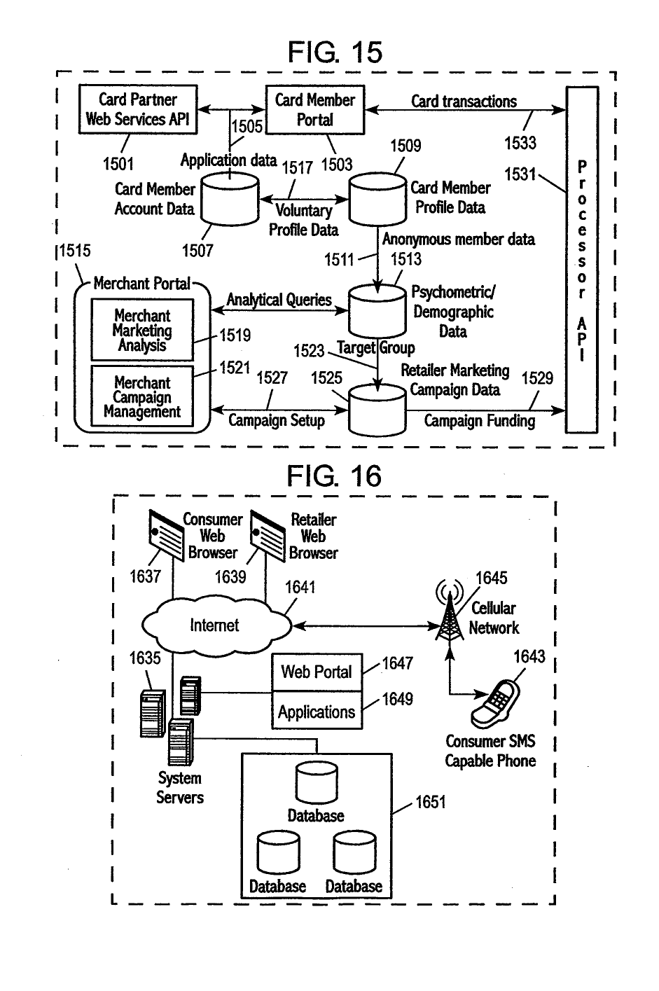

FIG. 15 illustrates an exemplary embodiment of the system architecture of the present invention. A series of databases may hold information for the processing of financial transactions. A financial instrument partner web services application program interface (API) 1501 may exchange information with a financial instrument member portal 1503. Application data 1505 from the financial instrument partner web services API 1501 and/or the financial instrument member portal 1503 may be entered into a user account database 1507. Application 1505 data may include information regarding the user and/or account information. Voluntary profile data 1517 from the user account database 1507 may be entered into a user profile database 1509. The user profile database 1509 may include any preferences or other information selected from the user account database 1507. Anonymous user data 1511 may be entered into a psychometric/demographic database 1513. The anonymous user data 1511 may be information filtered from the user profile database 1509 to remove any specific identifying information.

A party desiring to develop a promotional campaign portal 1515 may include, but is not limited to, a form of statistical, predictive or behavioral modeling 1519 and/or campaign management modules 1521. The party desiring to develop a promotional campaign portal 1515 may communicate information to and from the psychometric/demographic database 1513. The psychometric/demographic database 1513 may also send a target group 1523 to a marketing campaign database 1525. The marketing campaign database 1525 may communicate campaign setup information 1527 to and from the marketing campaign database 1525. Based upon the marketing campaign database 1525, campaign funding 1529 may be sent to a processor API 1531. The processor API 1532 may in turn communicate with the financial instrument member profile 1503 via financial instrument transactions 1533.

FIG. 16 shows in more detail an exemplary interaction of the central organization server 1635 with a consumer retail web browser 1637 and a party desiring to develop a promotional campaign web browser 1639 via the Internet 1641. The system servers 1635 may also be accessed by a consumer SMS-capable mobile phone or other similar device 1643 via a cellular network 1645, which may also pass through the Internet 1641. A web portal 1647 and related applications 1649 may also access the system servers 1635. The system servers 1635 in turn may access a series of databases 1651 to provide information to the consumer web browser 1637, party desiring to develop a promotional campaign web browser 1639 and/or the consumer phone 1643.

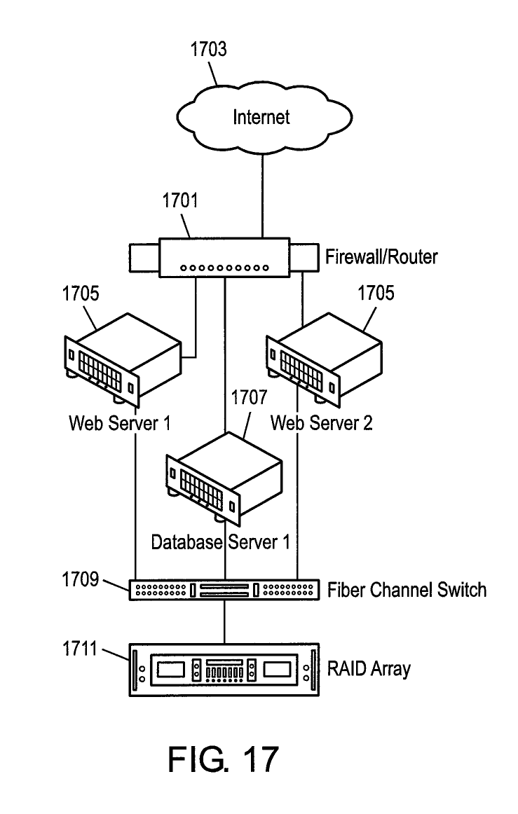

FIG. 17 illustrates an exemplary server and database configuration for the methods and systems of the present invention. A firewall/router 1701 may be in communication with the Internet 1703. The firewall/router 1701 may be in communication with one or more web servers 1705, one or more database servers 1707. Other numbers and configurations are possible. The web servers 1705 and database servers 1707 may be in communication with a fiber optic or other similar channel switch 1709. The channel switch 1709 may further be in communication with a redundant array of independent disks (RAID) array 1711.

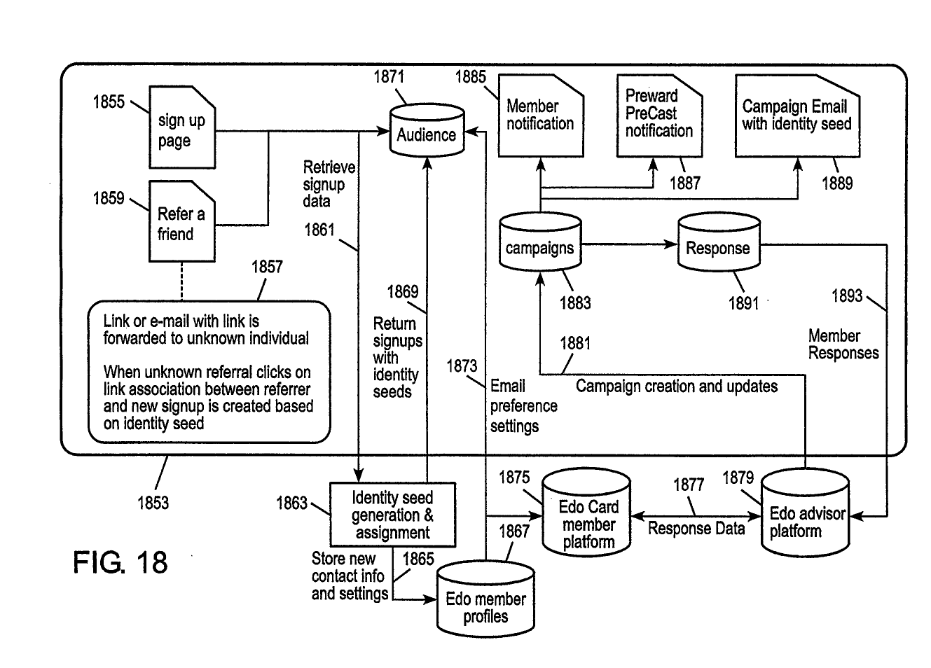

FIG. 18 illustrates an exemplary method and system of the present invention, which may use email or another similar system. An interface 1853 may interact with databases and platforms. The interface 1853 may include methods of signing up new users. For example, a new user may directly sign up via a sign up page 1855. Alternatively, a new user may be referred by a friend by clicking on a link 1857 leading to a refer a friend page 1859, or another standard referral method, such as entering a referral code in the sign up page 1855. The sign up process may cause sign up data to be retrieved 1861 and creation of an identity seed generation and assignment 1863. New contact information and setting may be stored 1865 in a user profile database 1867. Signup information with identity seeds 1869 may be returned to an audience database 1871. Email and other preference information 1873 may also be sent to the audience database 1871.

The user profile database 1867 may communicate with a user platform 1875. The user platform 1875 may communicate response data 1877 to and from a party desiring to develop a promotional campaign platform 1879. The party desiring to develop a promotional campaign platform may send campaign creation and updates 1881 to a campaigns database 1883. The campaigns database 1883 may communicate with a member notification 1885, promotion notification 1887 and/or campaign email with identity seed 1889 pages. The campaigns database 1883 may send information to a response database 1891. Member responses 1893 may be sent from the response database 1891 to the party desiring to develop a promotional campaign platform 1879.

Global positioning data from a global positioning system (GPS) may also be incorporated into the systems and methods of the present invention. Users may request information about party desiring to develop a promotional campaigns offering promotions based on the user's current GPS coordinates (latitude and longitude) as supplied by a mobile phone or other GPS enabled device. For example, a user may receive a promotion that may be used at a select group of restaurants that are part of a larger franchise. Furthermore, if the user is unsure about whether a particular establishment is part of the selected group, a text message (SMS), email, or other notification may be generated with the user's GPS coordinates. The notification may also contain a promotion identifier to identify the particular promotion in question. The notification may be sent to a server operated by the central organization. A response may be generated and returned to the user, by text message, email or another notification method, indicating whether the particular establishment is in the selected group of restaurants. In response to the user's notification, a lookup in a GPS coordinate database may be performed. Preferably, GPS coordinates for each party desiring to develop a promotional campaign's location are stored in the database. A match may be performed to between the user's coordinates and the GPS coordinates for the party desiring to develop a promotional campaign's locations to determine if the user falls within a determined radius of the party desiring to develop a promotional campaign's store coordinates.

If a user chooses to broadcast personal coordinates to the central organization's servers on a regular or periodic basis, promotions may be issued to a user based on the current geographic location of the user. As the user passes through different geographic regions, various regional promotions may be offered to the user.

As with most computer applications, security of information may be important. Security for the methods and systems of the present invention may be provided by a data vault. The data vault may protect user identities and monitor web service usage by partner portals to protect the privacy of users and to provide secure access and exchange of information with co-branded or private label partners.

Sensitive or identifying information may be stored in the data vault and may only be retrieved by properly authenticated programs using a universally unique identifier (UUID) and a private key. The data may be secured in the vault through network and operating system authorization and authentication and through the use of pretty good privacy (PGP) and/or public key/private key cryptography. Data may be encrypted using a public key as the data is inserted into the database. The data may require a private key kept by the central organization to decrypt the data for use in applications or reporting.

Only particular data may be released to party desiring to develop a promotional campaign. Specific and identifying information may be kept secure to protect the identities of the users. For example, a party desiring to develop a promotional campaign may be provided with latitude and longitude coordinates for a user's home address rather than the actual address. These coordinates may be reduced in precision to further protect the user's privacy. Despite the less precise information, the party desiring to develop a promotional campaign may still gain valuable demographic/geographic information without compromising the user's private data.

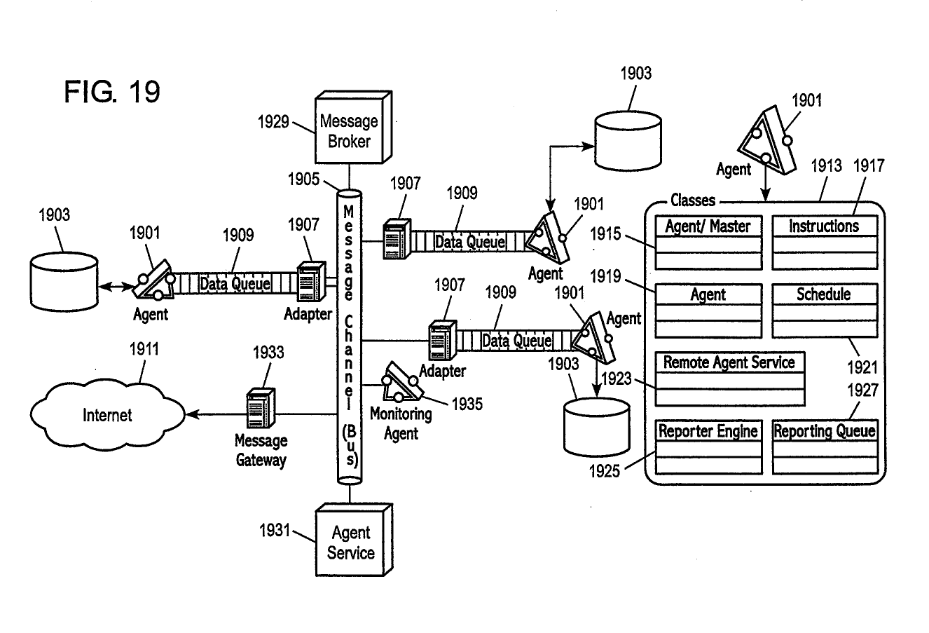

Real-time or near real-time acquisition of data may provide benefits in the methods and systems of the present invention. A distributed agent processing architecture, as shown in FIG. 19, may be used for real-time or near real-time acquisition of consumer data and behaviors for the purpose of offering purchase incentives. A series of agents 1901 may acquire, preprocess, move and update data between operational data stores 1903 within the network of the present invention and between web serves and other transactional or batch oriented interfaces with systems outside of the network of the present invention. A message channel (BUS) 1905 may communicate with adapters 1907. The adaptors may create a data queue 1909 for supplying information to and from an agent 1901. The agent may communicate with a database 1903. The message broker 1905 may also communicate with a message gateway 1933 in communication with the Internet 1911. An agent 1901 may process data in various classes 1913, such as, but not limited to, agent master 1915, instructions 1917, agent 1919, schedule 1921, remote agent service 1923, reporter engine 1925, and/or reporting queue 1927.

The message channel 1905 may also communicate with a message broker 1929 and/or an agent service 1931 and/or a monitoring agent 1935.

Distributed agent processing architecture may allow for rapid creation and analysis of consumer psychometric profiles. The distributed agent processing architecture may move data quickly and efficiently through a service oriented system so that stand alone applications can quickly and reliably share data with one another. The distributed agent processing architecture may eliminate the need to create a monolithic database that all applications would be required to access or replicate.

Distributed agents may have instruction sets that tell the agents what they are supposed to do on a scheduled or event-driven basis. Agents may each have unique schedules for executing instructions. An agent master may control the invocation and scheduling or agents. An agent may communicate through a messaging queue, either sending or receiving information. Agents may acquire data and send data to another agent for pre-processing, such as filtering data, transforming data into a more useful format, etc. Agent numbers may be increased to gain more overall throughput in the system. The use of distributed agent processing architecture may supply real-time information to the central organization and party desiring to develop a promotional campaign to improve promotion creation and processing.

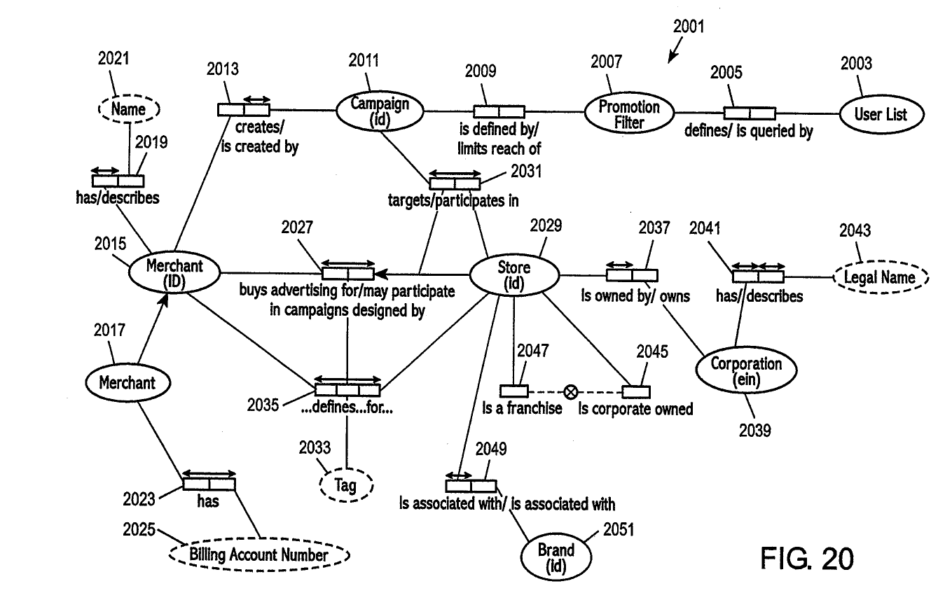

FIG. 20 illustrates an exemplary domain model 2001. A user list 2003 may be defined and/or queried by 2005 a promotion filter 2007. The promotion filter 2007 may be defined and/or limited by 2009 a promotional campaign identification 2011. The promotional campaign identification 2011 may in turn be created and/or defined by 2013 a merchant identifier 2015 corresponding to a merchant 2017. The merchant identifier 2015 may be described 2019 by a name 2021. The merchant identifier 2015 may have 2023 a billing account number 2025. The merchant 2017, via the merchant identifier 2015, may participate in a promotional campaign 2027 for a store identifier 2029. The store 2029 may participate 2031 in the campaign 2011. A tag 2033 may define 2035 the merchant identifier 2015 and/or the store identifier 2029.

The store 2029 may be owned by or owns 2037 a corporation or other similar entity 2039, which may have and/or be described by 2041 a legal name 2043. The store 2029 may either be owned by a corporation 2045 or may be a franchise 2047. The campaign 2011 may be valid at a corporate-owned location 2045 and/or a franchise 2047. The store 2029 may be associated with 2049 a brand 2051.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A method comprising:
providing access to a financial platform for at least one user wherein the financial platform is associated with financial services or financial networks,
providing a database of profile data for the at least one user,
receiving requests from a party desiring to develop a promotional campaign regarding desired characteristics of profile data of the at least one user,
processing the desired characteristics of profile data of the at least one user and the profile data for the at least one user for determining a set of selected users,
providing an offer for a promotion to the set of selected users,
receiving acceptance of the promotion from at least one user from the set of selected users,
providing promotions on the financial systems of the at least one user from the set of selected users accepting the offer for the promotion,
tracking redemption of the promotion, and
providing reports of redemption of the promotion to the party desiring to develop a promotional campaign.

2. The method of claim 1, wherein the financial services are selected from the group consisting of debit services, credit services, payroll services, and combinations thereof.

3. The method of claim 1, wherein the profile data is provided by the at least one user.

4. The method of claim 1, wherein the profile data is updated based upon transactions using the financial platform.

5. The method of claim 1, wherein the promotion is monetary value redeemable only with the party desiring to develop a promotional campaign.

6. The method of claim 1, wherein the promotion is monetary value issued to the financial platform based on a number of times the financial platform is used.

7. The method of claim 1, wherein the promotion is monetary value issued to the financial platform based on a value spent with the party desiring to develop a promotional campaign.

8. The method of claim 1, wherein the promotion is determined by geographical location of the at least one user.

9. The method of claim 8, wherein the geographical location of the at least one user is determined by a global positioning system.

10. The method of claim 1, further comprising tracking acceptance of the promotion from the set of selected users.

11. The method of claim 1, further comprising receiving rejection of the promotion from one or more of the set of selected users.

12. The method of claim 11, further comprising tracking rejection of the promotion from one or more of the set of selected users.

13. The method of claim 1, further comprising adapting future promotions based upon the tracking redemption of the promotion.

14. The method of claim 1, further comprising collecting feedback from the set of selected users.

15. The method of claim 1, wherein the at least one user manages the financial platform through a website.

16. The method of claim 1, wherein the at least one user selects preferences for receiving offers for promotions.

17. The method of claim 1, wherein the party desiring to develop a promotional campaign supplies funds to cover the promotion on the financial platform of the at least one user from the set of selected users accepting the offer for the promotion.

18. The method of claim 17, wherein unused funds are returned to the party desiring to develop a promotional campaign.

19. The method of claim 17, further comprising performing the method simultaneously for multiple parties desiring to develop promotional campaigns.

20. The method of claim 19, wherein the funds for each individual party desiring to develop a promotional campaign may not be used with other party desiring to develop a promotional campaign.

21. The method of claim 20, wherein the funds are held in separate sub-accounts for each individual party desiring to develop a promotional campaign within a main account.

22. The method of claim 1, wherein the promotion contains restrictions on use.

23. The method of claim 1, wherein the method is processed by a distributed agent software system.

24. The method of claim 1, further comprising providing real-time and post-promotional campaign statistical modeling, predictive modeling and analysis.

25. Computer readable code stored in a storage medium and executable by one or more processors, which when executed perform the method steps comprising:
receiving a set of promotion criteria from a party desiring to develop a promotional campaign,
accessing a database of user profiles,
producing a set of selected users based upon the promotion criteria and the database of user profiles,
communicating an offer for a promotion to the set of selected users,
receiving acceptance of the offer for the promotion at least one of the set of selected users,
transferring value specific to the party desiring to develop a promotional campaign to a financial platform of the at least one of the set of selected users accepting the offer for the promotion, and
tracking redemption of the value.

26. The computer readable code of claim 25, further comprising providing reports regarding the redemption of the value.

27. The computer readable code of claim 25, further comprising tracking rejection of the offer for the promotion and reporting rejection of the offer for the promotion to the party desiring to develop a promotional campaign.

28. The computer readable code of claim 25, further comprising tracking non-redemption of the value and reporting non-redemption of the value to the party desiring to develop a promotional campaign.

29. The computer readable code of claim 25, wherein the party desiring to develop a promotional campaign supplies funds to cover the promotion on the financial platform of the at least one of the set of selected users accepting the offer for the promotion.

30. The computer readable code of claim 29, wherein unused funds are returned to the party desiring to develop a promotional campaign.

31. The computer readable code of claim 29, further comprising performing the method simultaneously for multiple parties desiring to develop promotional campaigns.

32. The computer readable code of claim 31, wherein the funds for each individual party desiring to develop a promotional campaign may not be used with other party desiring to develop a promotional campaign.

33. The computer readable code of claim 32, wherein the funds are held in separate sub accounts for each individual party desiring to develop a promotional campaign within a main account.

34. A system comprising:
a server computer for receiving communications from a party desiring to develop a promotional campaign regarding parameters for a promotion,
a database communicating with the server computer for comparing the parameters against a database of user profile information for determining a select group of users,
wherein the server computer communicates an offer of the promotion to the select group of users and receives an acceptance of the promotion from at least one of the select group of users,
wherein the server computer transfers value to a financial platform of the at least one of the select group of users accepting the promotion, and
wherein the server computer tracks progress of the promotion and reports on the promotion to the party desiring to develop a promotional campaign.

35. The system of claim 34, wherein the value may only be redeemed at a location of the party desiring to develop a promotional campaign.
